(19) United States
(12) Patent Application Publication
(10) Pub. No.: US 2025/0297391 A1
(43) Pub. Date: Sep. 25, 2025

(54) ELECTROCHEMICAL CELL

(71) Applicant: NGK INSULATORS, LTD., Nagoya-shi (JP)

(72) Inventors: Genta TERAZAWA, Nagoya-shi (JP); Toshiyuki NAKAMURA, Handa-shi (JP); Takashi SHIRATORI, Nagoya-shi (JP); Makoto OHMORI, Nagoya-shi (JP)

(21) Appl. No.: 18/905,271

(22) Filed: Oct. 3, 2024

Related U.S. Application Data
(63) Continuation of application No. PCT/JP2024/010765, filed on Mar. 19, 2024.

(51) Int. Cl. C25B 15/08; C25B 1/04; C25B 9/60

(52) U.S. Cl. CPC C25B 15/08; C25B 9/60; C25B 1/04

(57) ABSTRACT

An electrochemical cell includes a gas container and a cell body portion. The gas container includes a metal support having a plurality of communication holes formed through a main surface thereof, a gas supply hole, and a gas discharge hole, a flow path member defining an internal space between the metal support and the flow path member, and a welded portion sealing a gap between the metal support and the flow path member. The internal space includes a gas supply chamber in communication with the gas supply hole, a gas discharge chamber in communication with the gas discharge hole, and a gas distribution chamber disposed between the gas supply chamber and the gas discharge chamber. When viewed in a plan view of the main surface, the welded portion includes a narrowing portion for dividing the gas distribution chamber from the gas supply chamber or the gas discharge chamber.

### CROSS-REFERENCE TO RELATED APPLICATION

This is a continuation of PCT/JP2024/010765 filed Mar. 19, 2024 the entire contents of which are hereby incorporated by reference.

### TECHNICAL FIELD

The present invention relates to an electrochemical cell.

### BACKGROUND ART

JP 2020-533737A discloses an electrochemical cell (electrolysis cell, fuel cell, etc.) including a cell body portion that is disposed on a gas container. The gas container includes a metal support having a plurality of communication holes formed through a main surface thereof, and a flow path member defining an internal space between the metal support and the flow path member. The metal support is welded to the flow path member.

### SUMMARY

In order to allow a current to flow smoothly inside a gas container, it is effective to increase the welding length by increasing the area of a main surface of a metal support. However, if the area of a main surface of a metal support is increased, the distance between the cell body portion and the welded portion becomes longer, resulting in current loss therebetween.

It is an object of the present invention to provide an electrochemical cell capable of suppressing current loss in a gas container.

A first aspect of the present invention is directed to an electrochemical cell including a gas container and a cell body portion. The gas container includes a metal support having a plurality of communication holes formed through a main surface thereof, a gas supply hole, and a gas discharge hole, a flow path member defining an internal space between the metal support and the flow path member, and a welded portion sealing a gap between the metal support and the flow path member. The cell body portion is disposed on the main surface and covers the plurality of communication holes. The internal space includes a gas supply chamber in communication with the gas supply hole, a gas discharge chamber in communication with the gas discharge hole, and a gas distribution chamber in communication with the plurality of communication holes, the gas distribution chamber being disposed between the gas supply chamber and the gas discharge chamber. When viewed in a plan view of the main surface, the welded portion includes a narrowing portion for dividing the gas distribution chamber from the gas supply chamber or the gas discharge chamber.

A second aspect of the present invention is directed to the electrochemical cell according to the first aspect, wherein when viewed in the plan view of the main surface, the gas container includes a recess formed along the narrowing portion.

A third aspect of the present invention is directed to the electrochemical cell according to the first or second aspect, wherein when viewed in the plan view of the main surface, a corner of the narrowing portion is rounded.

A fourth aspect of the present invention is directed to the electrochemical cell according to any one of the first to third aspects, wherein when viewed in the plan view of the main surface, in a case in which the narrowing portion divides the gas distribution chamber from the gas supply chamber, the welded portion includes a first portion facing the gas supply chamber, a corner of the first portion being rounded.

A fifth aspect of the present invention is directed to the electrochemical cell according to any one of the first to fourth aspects, wherein when viewed in the plan view of the main surface, in a case in which the narrowing portion divides the gas distribution chamber from the gas discharge chamber, the welded portion includes a second portion facing the gas discharge chamber, a corner of the second portion being rounded.

A sixth aspect of the present invention is directed to the electrochemical cell according to any one of the first to fifth aspects, wherein when viewed in the plan view of the main surface, the welded portion includes a third portion facing the gas distribution chamber, a corner of the third portion being rounded.

According to the present invention, it is possible to provide an electrochemical cell capable of suppressing current loss in a gas container.

### BRIEF DESCRIPTION OF DRAWINGS

FIG. 1 is a plan view of an electrolysis cell according to an embodiment.

FIG. 2 is a cross-sectional view taken along line A-A in FIG. 1.

FIG. 3 is a plan view of an electrolysis cell according to Variation 1.

FIG. 4 is a plan view of an electrolysis cell according to Variation 2.

FIGS. 5A to 5H are plan views of electrolysis cells according to Variation 4.

### DESCRIPTION OF EMBODIMENTS

### (Electrolysis Cell 1)

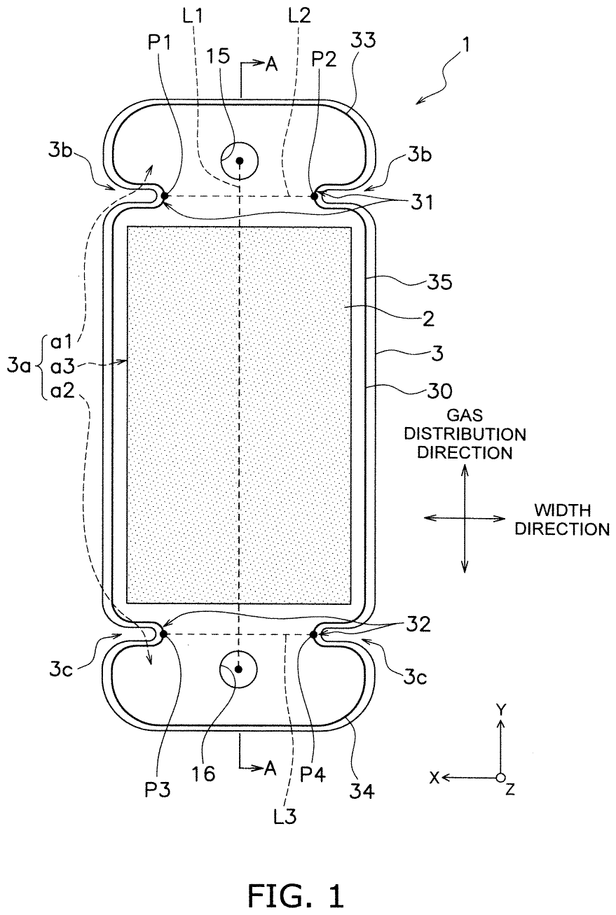

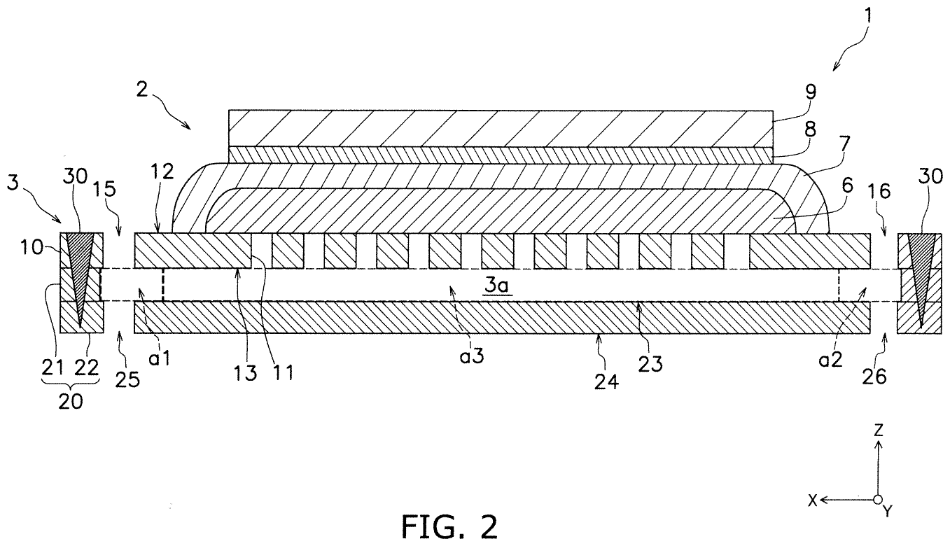

FIG. 1 is a plan view of an electrolysis cell 1 according to an embodiment. FIG. 2 is a cross-sectional view taken along line A-A in FIG. 1.

The electrolysis cell 1 is an example of an “electrochemical cell” according to the present invention. The electrolysis cell 1 is of a so-called metal support type.

The electrolysis cell 1 is shaped as a plate extending in an X-axis direction and a Y-axis direction. In the present embodiment, the electrolysis cell 1 is shaped as a rectangle extending in the Y-axis direction when viewed in a plan view from a Z-axis direction perpendicular to the X-axis direction and the Y-axis direction. However, the planar shape of the electrolysis cell 1 is not particularly limited, and may be a polygon other than a rectangle, such as an ellipse, a circle, or the like.

As shown in FIGS. 1 and 2, the electrolysis cell 1 includes a cell body portion 2 and a gas container 3.

### (Cell Body Portion 2)

The cell body portion 2 is supported by the gas container 3. The cell body portion 2 is disposed on a first main surface 12 of a later-described metal support 10 of the gas container 3.

As shown in FIG. 2, the cell body portion 2 includes a hydrogen electrode layer 6 (cathode), an electrolyte layer 7, a reaction prevention layer 8, and an oxygen electrode layer 9 (anode). The hydrogen electrode layer 6, the electrolyte layer 7, the reaction prevention layer 8, and the oxygen electrode layer 9 are stacked in this order from the gas container 3 side in the Z-axis direction. The hydrogen electrode layer 6, the electrolyte layer 7, and the oxygen electrode layer 9 are essential components, whereas the reaction prevention layer 8 is an optional component.

### [Hydrogen Electrode Layer 6]

The hydrogen electrode layer 6 is formed on the first main surface 12 of the metal support 10.

A raw material gas is supplied to the hydrogen electrode layer 6 through communication holes 11 in the metal support 10. The raw material gas contains at least water vapor (H₂O).

When the raw material gas contains only H₂O, the hydrogen electrode layer 6 produces H₂ from the raw material gas in accordance with water electrolysis, which is the electrochemical reaction shown in the following formula (1).

Hydrogen electrode layer 6: H₂O+2e⁻→H₂+O²⁻ (1)

When the raw material gas contains CO₂ in addition to H₂O, the hydrogen electrode layer 6 produces H₂, CO, and O²⁻ from the raw material gas in accordance with co-electrolysis, which are the electrochemical reactions shown in the following formulas (2), (3), and (4).

Hydrogen electrode layer 6: CO₂+H₂O+4e⁻→CO+H₂+2O²⁻ (2)

H₂O electrochemical reaction: H₂O+2e⁻→H₂+O²⁻ (3)

CO₂ electrochemical reaction: CO₂+2e⁻→CO+O²⁻ (4)

H₂ produced in the hydrogen electrode layer 6 flows out from the communication holes 11 of the metal support 10 into a later-described internal space 3a.

The hydrogen electrode layer 6 is a porous body that has electronic conductivity. The hydrogen electrode layer 6 contains nickel (Ni). In the case of co-electrolysis, Ni functions as an electronic conductor, and also functions as a thermal catalyst that promotes the thermal reaction between the produced H₂ and the CO₂ contained in the raw material gas to maintain an appropriate gas composition for methanation, Fischer-Tropsch (FT) synthesis, and the like. The Ni contained in the hydrogen electrode layer 6 is essentially present in the form of metal Ni during operation of the electrolysis cell 1, but may also partially be present in the form of nickel oxide (NiO).

The hydrogen electrode layer 6 may contain an ion conductive material. Examples of the ion conductive material that can be used include yttria-stabilized zirconia (YSZ), calcia-stabilized zirconia (CSZ), scandia-stabilized zirconia (ScSZ), gadolinium-doped ceria (GDC), samarium-doped ceria (SDC), (La, Sr)(Cr, Mn)O₃, (La, Sr)TiO₃, Sr₂(Fe, Mo)₂O₆, (La, Sr)VO₃, (La, Sr)FeO₃, and mixed materials containing two or more of these.

The porosity of the hydrogen electrode layer 6 is not particularly limited, but can be, for example, 5% or more and 70% or less. The thickness of the hydrogen electrode layer 6 is not particularly limited, but can be, for example, 1 μm or more and 100 μm or less.

The method for forming the hydrogen electrode layer 6 is not particularly limited, and a firing method, a spray coating method (such as a thermal spray method, an aerosol deposition method, an aerosol gas deposition method, a powder jet deposition method, a particle jet deposition method, or a cold spray method), a PVD method (such as a sputtering method or a pulsed laser deposition method), a CVD method, or the like can be used.

### [Electrolyte Layer 7]

The electrolyte layer 7 is formed on the hydrogen electrode layer 6. The electrolyte layer 7 is disposed between the hydrogen electrode layer 6 and the oxygen electrode layer 9. In the present embodiment, the electrolyte layer 7 is sandwiched between the hydrogen electrode layer 6 and the reaction prevention layer 8 and is connected to both of them.

The electrolyte layer 7 covers the hydrogen electrode layer 6 and is connected to the first main surface 12 of the metal support 10.

The electrolyte layer 7 is a dense body that has oxide ion conductivity. The electrolyte layer 7 transfers O²⁻ produced in the hydrogen electrode layer 6 toward the oxygen electrode layer 9. The electrolyte layer 7 is constituted by an oxide ion conductive material. The electrolyte layer 7 can be constituted by, for example, YSZ, GDC, ScSZ, SDC, LSGM (lanthanum gallate), or the like, with YSZ being particularly preferable.

The porosity of the electrolyte layer 7 is not particularly limited, but can be, for example, 0.1% or more and 7% or less. The thickness of the electrolyte layer 7 is not particularly limited, but can be, for example, 1 μm or more and 100 μm or less.

The method for forming the electrolyte layer 7 is not particularly limited, and a firing method, a spray coating method, a PVD method, a CVD method, or the like can be used.

### [Reaction Prevention Layer 8]

The reaction prevention layer 8 is disposed between the electrolyte layer 7 and the oxygen electrode layer 9. The reaction prevention layer 8 is disposed on the side of the electrolyte layer 7 opposite to the hydrogen electrode layer 6 side. The reaction prevention layer 8 suppresses the formation of a layer with high electrical resistance caused by constituent elements of the electrolyte layer 7 reacting with constituent elements of the oxygen electrode layer 9.

The reaction prevention layer 8 is constituted by an oxide ion conductive material. The reaction prevention layer 8 can be constituted by GDC, SDC, or the like.

The porosity of the reaction prevention layer 8 is not particularly limited, but can be, for example, 0.1% or more and 50% or less. The thickness of the reaction prevention layer 8 is not particularly limited, but may be, for example, 1 μm or more and 50 μm or less.

The method for forming the reaction prevention layer 8 is not particularly limited, and a firing method, a spray coating method, a PVD method, a CVD method, or the like can be used.

### [Oxygen Electrode Layer 9]

The oxygen electrode layer 9 is disposed on the side of the electrolyte layer 7 opposite to the hydrogen electrode layer 6 side. In the present embodiment, the reaction prevention layer 8 is disposed between the electrolyte layer 7 and the oxygen electrode layer 9, and therefore the oxygen electrode layer 9 is connected to the reaction prevention layer 8. When the reaction prevention layer 8 is not disposed between the electrolyte layer 7 and the oxygen electrode layer 9, the oxygen electrode layer 9 is connected to the electrolyte layer 7.

The oxygen electrode layer 9 produces O₂ from O²⁻ transferred from the hydrogen electrode layer 6 via the electrolyte layer 7 in accordance with the chemical reaction of the following formula (5).

Oxygen electrode layer 9:2O²⁻→O₂+4e⁻ (5)

The oxygen electrode layer 9 is a porous body that has oxide ion conductivity and electronic conductivity. The oxygen electrode layer 9 can be constituted by, for example, a composite material containing an oxide ion conductive material (such as GDC) and one or more of (La, Sr)(Co, Fe)O₃, (La, Sr)FeO₃, La(Ni, Fe)O₃, (La, Sr)CoO₃, and (Sm, Sr)COO₃.

The porosity of the oxygen electrode layer 9 is not particularly limited, but can be, for example, 20% or more and 60% or less. The thickness of the oxygen electrode layer 9 is not particularly limited, but can be, for example, 1 μm or more and 100 μm or less.

The method for forming the oxygen electrode layer 9 is not particularly limited, and a firing method, a spray coating method, a PVD method, a CVD method, or the like can be used.

### (Gas Container 3)

The gas container 3 supports the cell body portion 2. The gas container 3 is used to supply and discharge gas. The gas container 3 supplies a raw material gas to the cell body portion 2 (specifically, the hydrogen electrode layer 6). The gas container 3 discharges a product gas produced in the hydrogen electrode layer 6 and remaining raw material gas not consumed in the cell body portion 2 (specifically, the hydrogen electrode layer 6) to the outside.

The gas container 3 includes the metal support 10, a flow path member 20, and a welded portion 30. The gas container 3 has the internal space 3a therein.

### [Metal Support 10]

The metal support 10 supports the cell body portion 2. In the present embodiment, the metal support 10 is formed in a plate shape. The metal support 10 may be shaped as a flat plate or a curved plate.

The metal support 10 is only required to be able to support the cell body portion 2, and the thickness thereof is not particularly limited, but can be, for example, 0.1 mm or more and 2.0 mm or less.

The metal support 10 includes the plurality of communication holes 11, the first main surface 12, and a second main surface 13.

The communication holes 11 are formed through the first main surface 12. The communication holes 11 pass through the metal support 10 from the first main surface 12 to the second main surface 13. The communication holes 11 are open at both the first main surface 12 and the second main surface 13. The openings of the communication holes 11 on the first main surface 12 side are covered by the cell body portion 2 (specifically, the hydrogen electrode layer 6). The openings of the communication holes 11 on the second main surface 13 side are in communication with a later-described gas distribution chamber a3 in the internal space 3a.

The communication holes 11 can be formed by mechanical processing (e.g., punching), laser processing, chemical processing (e.g., etching), or the like.

In the present embodiment, the communication holes 11 extend straight along the Z-axis direction. However, the communication holes 11 may be inclined with respect to the Z-axis direction, and do not need to be linear. Moreover, the communication holes 11 may be connected to each other.

The first main surface 12 is provided on the side opposite to the second main surface 13. The cell body portion 2 is disposed on the first main surface 12. The flow path member 20 is joined to the second main surface 13.

The metal support 10 has a gas supply hole 15 and a gas discharge hole 16.

The gas supply hole 15 is formed through the first main surface 12. The gas supply hole 15 passes through the metal support 10 from the first main surface 12 to the second main surface 13. The gas supply hole 15 is open at both the first main surface 12 and the second main surface 13. The opening of the gas supply hole 15 on the first main surface 12 side is in communication with a gas supply hole 25 of a flow path member 20 included in another electrolysis cell 1 (not shown). The opening of the gas supply hole 15 on the second main surface 13 side is in communication with a later-described gas supply chamber a1 in the internal space 3a.

The gas discharge hole 16 is formed through the first main surface 12. The gas discharge hole 16 passes through the metal support 10 from the first main surface 12 to the second main surface 13. The gas discharge hole 16 is open at both the first main surface 12 and the second main surface 13. The opening of the gas discharge hole 16 on the first main surface 12 side is in communication with a gas discharge hole 26 of a flow path member 20 included in another electrolysis cell 1 (not shown). The opening of the gas discharge hole 16 on the second main surface 13 side is in communication with a later-described gas discharge chamber a2 in the internal space 3a.

The metal support 10 is constituted by a metal material. For example, the metal support 10 is constituted by an alloy material containing Cr (chromium). Examples of such metal materials include Fe—Cr alloy steel (such as stainless steel) and Ni—Cr alloy steel. The Cr content in the metal support 10 is not particularly limited, but can be 4 mass % or more and 30 mass % or less.

The metal support 10 may contain Ti (titanium) and/or Zr (zirconium). The Ti content in the metal support 10 is not particularly limited, but can be 0.01 mol % or more and 1.0 mol % or less. The Zr content in the metal support 10 is not particularly limited, but can be 0.01 mol % or more and 0.4 mol % or less. The metal support 10 may contain Ti as TiO₂ (titania) and Zr as ZrO₂ (zirconia).

### [Flow Path Member 20]

The flow path member 20 is joined to the metal support 10. The flow path member 20 is joined to the metal support 10 via the welded portion 30. That is to say, the flow path member 20 is welded to the metal support 10.

The flow path member 20 is constituted by a metal material. For example, the flow path member 20 can be constituted by the above-mentioned alloy materials. The material composition of the flow path member 20 may be the same as or different from that of the metal support 10.

The flow path member 20 includes a frame 21 and an interconnector 22. In the present embodiment, the frame 21 and the interconnector 22 are separate members. The frame 21 is joined to the interconnector 22 via the welded portion 30. That is to say, the frame 21 is welded to the interconnector 22.

The frame 21 is formed in an annular shape. The frame 21 is disposed along the outer edge of the interconnector 22. The frame 21 functions as a spacer for forming a gap between the metal support 10 and the interconnector 22. The thickness of the frame 21 is not particularly limited, but can be, for example, 0.1 mm or more and 2.0 mm or less.

The interconnector 22 is disposed on the side of the frame 21 opposite to the metal support 10 side. The interconnector 22 is an electrical connection member for electrically connecting the electrolysis cell 1 to another electrolysis cell or an external power source. The interconnector 22 is formed in a plate shape. The interconnector 22 may be shaped as a flat plate or a curved plate. The thickness of the interconnector 22 is not particularly limited, but can be, for example, 0.1 mm or more and 2.0 mm or less.

The interconnector 22 includes a first main surface 23 and a second main surface 24. The first main surface 23 faces the second main surface 13 of the metal support 10. The second main surface 24 is provided on the side opposite to the first main surface 23.

The interconnector 22 has a gas supply hole 25 and a gas discharge hole 26.

The gas supply hole 25 is formed through the first main surface 23. The gas supply hole 25 passes through the interconnector 22 from the first main surface 23 to the second main surface 24. The opening of the gas supply hole 25 on the first main surface 23 side is in communication with a later-described gas supply chamber a1 in the internal space 3a. The opening of the gas supply hole 25 on the second main surface 24 side is in communication with a gas supply hole 15 of a metal support 10 included in another electrolysis cell 1 (not shown).

The gas discharge hole 26 is formed through the first main surface 23. The gas discharge hole 26 passes through the interconnector 22 from the first main surface 23 to the second main surface 24. The gas discharge hole 26 is open at both the first main surface 23 and the second main surface 24. The opening of the gas discharge hole 26 on the first main surface 23 side is in communication with a later-described gas discharge chamber a2 in the internal space 3a. The opening of the gas discharge hole 26 on the second main surface 24 side is in communication with a gas discharge hole 16 of a metal support 10 included in another electrolysis cell 1 (not shown).

[Internal Space 3a]

The internal space 3a is a space between the metal support 10 and the flow path member 20. The outer periphery of the internal space 3a in the planar direction is sealed by the welded portion 30.

As shown in FIGS. 1 and 2, the internal space 3a is constituted by the gas supply chamber a1, the gas discharge chamber a2, and the gas distribution chamber a3.

The gas supply chamber a1 is in communication with the gas supply hole 15 of the metal support 10. The gas supply chamber a1 is in communication with the gas supply hole 25 of the flow path member 20. The gas supply chamber a1 is in communication with the gas distribution chamber a3 in a gas distribution direction.

In this specification, the gas distribution direction means the direction that is parallel to a straight line L1 connecting the geometric center of the gas supply hole 15 and the geometric center of the gas discharge hole 16 when viewed in a plan view of the first main surface 12 of the metal support 10. In the following description, when viewed in a plan view of the first main surface 12 of the metal support 10, the direction that is perpendicular to the gas distribution direction is referred to as a width direction.

The gas discharge chamber a2 is in communication with the gas discharge hole 16 of the metal support 10. The gas discharge chamber a2 is in communication with the gas discharge hole 26 of the flow path member 20. The gas discharge chamber a2 is in communication with the gas distribution chamber a3 in the gas distribution direction. The gas discharge chamber a2 is disposed on the side of the gas distribution chamber a3 opposite to the gas supply chamber a1 side in the gas distribution direction.

The gas distribution chamber a3 is in communication with the communication holes 11 of the metal support 10. The gas distribution chamber a3 is disposed between the gas supply chamber a1 and the gas discharge chamber a2 in the gas distribution direction.

A raw material gas is supplied from the gas supply hole 15 of the metal support 10 or the gas supply hole 25 of the flow path member 20 to the gas supply chamber a1. The raw material gas flowing into the gas supply chamber a1 flows from the gas supply chamber a1 into the gas distribution chamber a3. The raw material gas flowing into the gas distribution chamber a3 flows from the gas distribution chamber a3 into the communication holes 11 of the metal support 10. A product gas produced in the hydrogen electrode layer 6 flows from the communication holes 11 of the metal support 10 into the gas distribution chamber a3. The product gas produced in the hydrogen electrode layer 6 and remaining raw material gas not consumed in the hydrogen electrode layer 6 flow from the gas distribution chamber a3 into the gas discharge chamber a2. The product gas and the remaining raw material gas flowing into the gas discharge chamber a2 are discharged from the gas discharge hole 16 of the metal support 10 or the gas discharge hole 26 of the flow path member 20 to the outside.

### [Welded Portion 30]

As shown in FIG. 1, the welded portion 30 includes first narrowing portions 31 and second narrowing portions 32. The first narrowing portions 31 and the second narrowing portions 32 are each an example of a “narrowing portion” according to the present invention.

The first narrowing portions 31 are formed between the gas supply hole 15 of the metal support 10 and the cell body portion 2 when viewed in a plan view of the first main surface 12 of the metal support 10. The first narrowing portions 31 are recesses formed so as to project inward in the width direction of the internal space 3a. In other words, the first narrowing portions 31 form a portion of the welded portion 30 that has a smaller width in the width direction. The first narrowing portions 31 form a portion having a smaller width than that of a portion upstream of the first narrowing portions 31 in the welded portion 30 and having a smaller width than that of a portion downstream of the first narrowing portions 31 in the welded portion 30. Accordingly, the width of the welded portion 30 in the width direction is partially smaller at the first narrowing portions 31.

As shown in FIG. 1, the first narrowing portions 31 divide the gas supply chamber a1 from the gas distribution chamber a3. The space in the internal space 3a that is upstream of the first narrowing portions 31 is the gas supply chamber a1, and the space in the internal space 3a that is downstream of the first narrowing portions 31 is the gas distribution chamber a3. Specifically, the space upstream of a straight line L2 that passes through innermost points P1 and P2 of the first narrowing portions 31 and is parallel to the width direction is the gas supply chamber a1, and the space downstream of the straight line L2 is the gas distribution chamber a3.

Since the welded portion 30 includes the first narrowing portions 31, it is possible to provide the gas supply chamber a1 divided from the gas distribution chamber a3 by the first narrowing portions 31. This increases the area of the first main surface 12 of the metal support 10 and also increases the length of the welded portion 30 compared with the case in which the gas supply chamber a1 is not present. Thus, it is possible to allow a current to flow smoothly inside the gas container 3.

Furthermore, since the welded portion 30 includes the first narrowing portions 31, part of the welded portion 30 can be extended in the width direction along the cell body portion 2. Therefore, the distance between the cell body portion 2 and the first narrowing portions 31 of the welded portion 30 can be shortened, and thus current loss between the cell body portion 2 and the welded portion 30 can be suppressed.

As described above, since the welded portion 30 includes the first narrowing portions 31, it is possible to suppress current loss in the gas container 3, while allowing a current to flow smoothly inside the gas container 3.

The second narrowing portions 32 are formed between the gas discharge hole 16 of the metal support 10 and the cell body portion 2 when viewed in a plan view of the first main surface 12 of the metal support 10. The second narrowing portions 32 are recesses formed so as to project inward in the width direction of the internal space 3a. In other words, the second narrowing portions 32 form a portion of the welded portion 30 that has a smaller width in the width direction. The second narrowing portions 32 form a portion having a smaller width than that of a portion upstream of the second narrowing portions 32 in the welded portion 30 and having a smaller width than that of a portion downstream of the second narrowing portions 32 in the welded portion 30. Accordingly, the width of the welded portion 30 in the width direction is partially smaller at the second narrowing portions 32.

As shown in FIG. 1, the second narrowing portions 32 divide the gas discharge chamber a2 from the gas distribution chamber a3. The space in the internal space 3a that is upstream of the second narrowing portions 32 is the gas distribution chamber a3, and the space in the internal space 3a that is downstream of the second narrowing portions 32 is the gas discharge chamber a2. Specifically, the space upstream of a straight line L3 that passes through innermost points P3 and P4 of the second narrowing portions 32 and is parallel to the width direction is the gas distribution chamber a3, and the space downstream of the straight line L3 is the gas discharge chamber a2.

Since the welded portion 30 includes the second narrowing portions 32, it is possible to provide the gas discharge chamber a2 divided from the gas distribution chamber a3 by the second narrowing portions 32. This increases the area of the first main surface 12 of the metal support 10 and also increases the length of the welded portion 30 compared with the case in which the gas discharge chamber a2 is not present. Thus, it is possible to allow a current to flow smoothly inside the gas container 3.

Furthermore, since the welded portion 30 includes the second narrowing portions 32, part of the welded portion 30 can be extended in the width direction along the cell body portion 2. Therefore, the distance between the cell body portion 2 and the second narrowing portions 32 of the welded portion 30 can be shortened, and thus current loss between the cell body portion 2 and the welded portion 30 can be suppressed.

As described above, since the welded portion 30 includes the second narrowing portions 32, it is possible to suppress current loss in the gas container 3, while allowing a current to flow smoothly inside the gas container 3.

As shown in FIG. 1, the welded portion 30 includes a first portion 33, a second portion 34, and third portions 35.

The first portion 33 is a portion of the welded portion 30 that faces the gas supply chamber a1. The first portion 33 includes part of the first narrowing portions 31. Specifically, the first portion 33 includes portions of the first narrowing portions 31 that are upstream of the innermost points P1 and P2 respectively.

As shown in FIG. 1, the corners of the first portion 33 are preferably rounded when viewed in a plan view. This allows the corners of the gas supply chamber a1 to be streamlined, thereby suppressing the accumulation of gas in the corners of the gas supply chamber a1, and allowing gas to flow smoothly inside the gas supply chamber a1. In this specification, the corners each mean a portion in which two straight lines are connected when viewed in a plan view.

The second portion 34 is a portion of the welded portion 30 that faces the gas discharge chamber a2. The second portion 34 includes part of the second narrowing portions 32. Specifically, the second portion 34 includes portions of the second narrowing portions 32 that are downstream of the innermost points P3 and P4 respectively.

As shown in FIG. 1, the corners of the second portion 34 are preferably rounded when viewed in a plan view. This allows the corners of the gas discharge chamber a2 to be streamlined, thereby suppressing the accumulation of gas in the corners of the gas discharge chamber a2, and allowing gas to flow smoothly inside the gas discharge chamber a2.

The third portions 35 are portions of the welded portion 30 that each face the gas distribution chamber a3. The third portions 35 include part of the first narrowing portions 31 and part of the second narrowing portions 32. Specifically, the third portions 35 include a portion that is downstream of the innermost point P1 of the first narrowing portion 31 and is upstream of the innermost point P3 of the second narrowing portion 32, and a portion that is downstream of the innermost point P2 of the first narrowing portion 31 and is upstream of the innermost point P4 of the second narrowing portion 32.

As shown in FIG. 1, the corners of the third portions 35 are preferably rounded when viewed in a plan view. This allows the corners of the gas distribution chamber a3 to be streamlined, thereby suppressing the accumulation of gas in the corners of the gas distribution chamber a3, and allowing gas to flow smoothly inside the gas distribution chamber a3.

Furthermore, as shown in FIG. 1, the corners of the first narrowing portions 31 are preferably rounded when viewed in a plan view. This allows the corners of the first narrowing portions 31 to be streamlined, thereby allowing gas to flow smoothly from the gas supply chamber a1 to the gas distribution chamber a3, and suppressing the case where the first narrowing portions 31 interrupt the flow of current from the cell body portion 2 to the first portion 33 of the welded portion 30.

Furthermore, as shown in FIG. 1, the corners of the second narrowing portions 32 are preferably rounded when viewed in a plan view. This allows the corners of the second narrowing portions 32 to be streamlined, thereby allowing gas to flow smoothly from the gas distribution chamber a3 to the gas discharge chamber a2, and suppressing the case where the second narrowing portions 32 interrupt the flow of current from the cell body portion 2 to the second portion 34 of the welded portion 30.

Furthermore, as shown in FIG. 1, when viewed in a plan view of the first main surface 12 of the metal support 10, the gas container 3 preferably includes first recesses 3b formed along the first narrowing portions 31. This allows the gas container 3 to be flexible, thereby improving the durability of the gas container 3. From this viewpoint, the corners of the first recesses 3b are more preferably rounded when viewed in a plan view.

The first recesses 3b are formed between the gas supply hole 15 of the metal support 10 and the cell body portion 2 when viewed in a plan view of the first main surface 12 of the metal support 10. The first recesses 3b are formed so as to project inward in the width direction of the internal space 3a. The width of the gas container 3 in the width direction is partially smaller at the first recesses 3b.

In a similar manner, as shown in FIG. 1, when viewed in a plan view of the first main surface 12 of the metal support 10, the gas container 3 preferably includes second recesses 3c formed along the second narrowing portions 32. This allows the gas container 3 to be flexible, thereby improving the durability of the gas container 3. From this viewpoint, the corners of the second recesses 3c are more preferably rounded when viewed in a plan view.

The second recesses 3c are formed between the gas discharge hole 16 of the metal support 10 and the cell body portion 2 when viewed in a plan view of the first main surface 12 of the metal support 10. The second recesses 3c are formed so as to project inward in the width direction of the internal space 3a. The width of the gas container 3 in the width direction is partially smaller at the second recesses 3c.

### Variations of Embodiment

Although an embodiment of the present invention has been described above, the present invention is not limited to the foregoing embodiment, and various modifications can be made without departing from the gist of the present invention.

### [Variation 1]

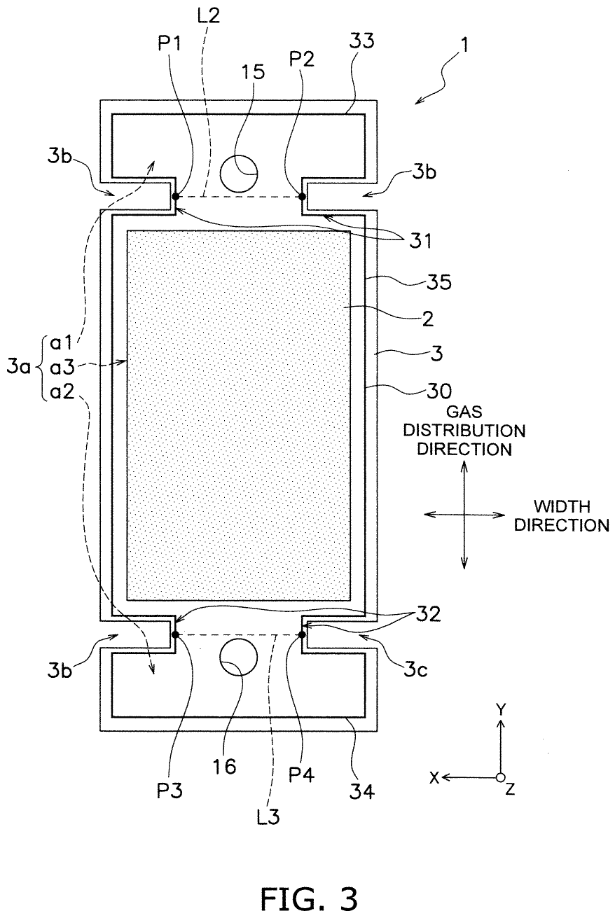

In the foregoing embodiment, the corners of all the first narrowing portions 31, the second narrowing portions 32, the first portion 33, the second portion 34, and the third portions 35 of the welded portion 30 are rounded, but there is no limitation to this. As shown in FIG. 3, the corners of at least one of the first narrowing portions 31, the second narrowing portions 32, the first portion 33, the second portion 34 and, the third portions 35 of the welded portion 30 may be sharp corners.

### [Variation 2]

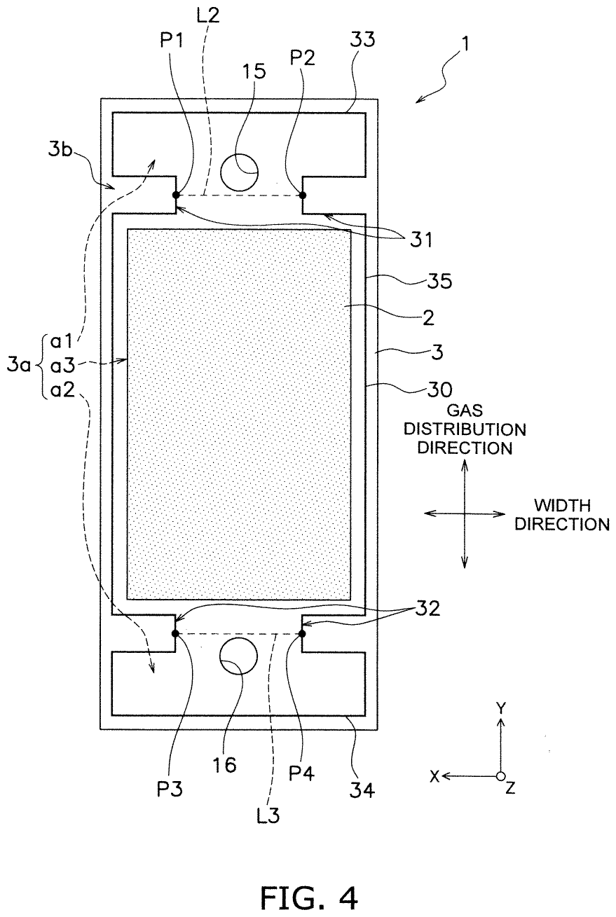

In the foregoing embodiment, the gas container 3 includes the first recesses 3b and the second recesses 3c, but there is no limitation to this. As shown in FIG. 4, the gas container 3 does not need to include at least one of the first recesses 3b and the second recesses 3c.

### [Variation 3]

In the foregoing embodiment, the welded portion 30 is bilaterally symmetrical in the width direction, but there is no limitation to this.

For example, the first narrowing portions 31 do not need to be provided on both sides in the width direction, and a recess may be provided on only one side in the width direction. In a similar manner, the second narrowing portions 32 do not need to be provided on both sides in the width direction, and a recess may be provided on only one side in the width direction.

### [Variation 4]

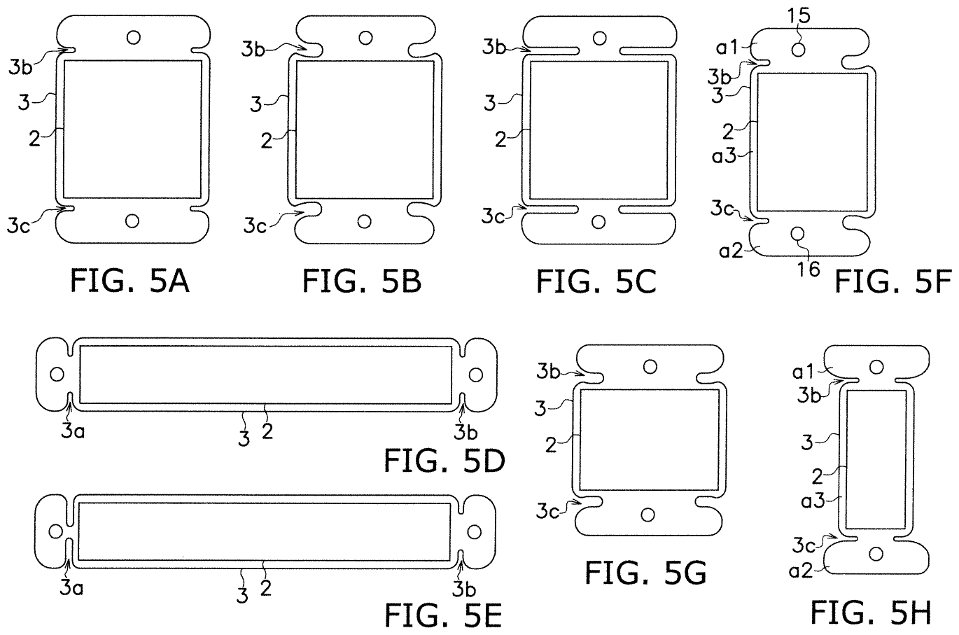

In the foregoing embodiment, the electrolysis cell 1 is shaped as a rectangle extending in the Y-axis direction, but the shape of the electrolysis cell 1 may be changed as appropriate as shown in FIGS. 5A to 5H. Specifically, as shown in FIGS. 5A to 5E, the depth of the first recesses 3b and the second recesses 3c of the gas container 3 may be changed as appropriate. As shown in FIG. 5F, in the gas container 3, the first recesses 3b and the second recesses 3c may be asymmetrical in the width direction, the gas supply hole 15 and the gas discharge hole 16 may be off-center in the width direction, and the width of the gas supply chamber a1 and the gas discharge chamber a2 may be smaller than that of the gas distribution chamber a3. As shown in FIG. 5G, the cell body portion 2 may be shaped as a rectangle extending in the X-axis direction. As shown in FIG. 5H, in the gas container 3, the width of the gas supply chamber a1 and the gas discharge chamber a2 may be larger than that of the gas distribution chamber a3.

### [Variation 5]

In the foregoing embodiment, the frame 21 and the interconnector 22 constituting the flow path member 20 are separate members, but the frame 21 and the interconnector 22 may be an integrated member.

### [Variation 6]

In the foregoing embodiment, an electrolysis cell has been described as an example of an electrochemical cell, but the electrochemical cell is not limited to an electrolysis cell. An electrochemical cell is a general term for an element in which a pair of electrodes are arranged so that electromotive force is produced from an overall oxidation-reduction reaction in order to convert electrical energy into chemical energy, and for an element for converting chemical energy into electrical energy. Thus, electrochemical cells include, for example, fuel cells that use oxide ions or protons as carriers.

### REFERENCE SIGNS LIST

1 Electrolysis cell
2 Cell body portion
6 Hydrogen electrode layer
7 Electrolyte layer
8 Reaction prevention layer
9 Oxygen electrode layer
3 Gas container
3a Internal space
a1 Gas supply chamber
a2 Gas discharge chamber
a3 Gas distribution chamber
3b First recess
3C Second recess
10 Metal support
11 Communication hole
12 First main surface
13 Second main surface
15 Gas supply hole
16 Gas discharge hole
20 Flow path member
21 Frame
22 Interconnector
30 Welded portion
31 First narrowing portion
32 Second narrowing portion
33 First portion
34 Second portion
35 Third portion

1. An electrochemical cell comprising:
a gas container including
a metal support having a plurality of communication holes formed through a main surface thereof, a gas supply hole, and a gas discharge hole,
a flow path member defining an internal space between the metal support and the flow path member, and
a welded portion sealing a gap between the metal support and the flow path member; and
a cell body portion disposed on the main surface and covering the plurality of communication holes; wherein
the internal space includes a gas supply chamber in communication with the gas supply hole, a gas discharge chamber in communication with the gas discharge hole, and a gas distribution chamber in communication with the plurality of communication holes, the gas distribution chamber being disposed between the gas supply chamber and the gas discharge chamber, and
when viewed in a plan view of the main surface, the welded portion includes a narrowing portion for dividing the gas distribution chamber from the gas supply chamber or the gas discharge chamber.

2. The electrochemical cell according to claim 1, wherein
when viewed in the plan view of the main surface, the gas container includes a recess formed along the narrowing portion.

3. The electrochemical cell according to claim 1, wherein
when viewed in the plan view of the main surface, a corner of the narrowing portion is rounded.

4. The electrochemical cell according to claim 1, wherein
when viewed in the plan view of the main surface, in a case in which the narrowing portion divides the gas distribution chamber from the gas supply chamber, the welded portion includes a first portion facing the gas supply chamber, a corner of the first portion being rounded.

5. The electrochemical cell according to claim 1, wherein
when viewed in the plan view of the main surface, in a case in which the narrowing portion divides the gas distribution chamber from the gas discharge chamber, the welded portion includes a second portion facing the gas discharge chamber, a corner of the second portion being rounded.

6. The electrochemical cell according to claim 1, wherein
when viewed in the plan view of the main surface, the welded portion includes a third portion facing the gas distribution chamber, a corner of the third portion being rounded.
